(19) United States
(12) Patent Application Publication
(10) Pub. No.: US 2023/0176276 A1
(43) Pub. Date: Jun. 8, 2023

(54) LIGHTGUIDE AUGMENTED REALITY EYEPIECE AND METHOD FOR MANUFACTURING

(71) Applicant: AURORATECH COMPANY, Burlingame, CA (US)

(72) Inventors: Ziqi Peng, Burlingame, CA (US); Bayley Wang, Burlingame, CA (US); Mark Flowers, Los Gatos, CA (US); Justin Krenz, Oakland, CA (US)

(73) Assignee: AURORATECH COMPANY, Burlingame, CA (US)

(21) Appl. No.: 17/992,824

(22) Filed: Nov. 22, 2022

Related U.S. Application Data
(60) Provisional application No. 63/281,964, filed on Nov. 22, 2021.

(51) Int. Cl. F21V 8/00; G02B 27/01

(52) U.S. Cl. CPC G02B 6/0055; G02B 27/0101

(57) ABSTRACT

A lightguide type augmented reality headset (ARHS) eyepiece having one or more dimensions much thicker than one wavelength of visible light with one or more embedded reflectors. The eyepiece consists of a laminated set of optically transparent layers and/or a single outcoupling region made of an optically transparent material.

### CROSS-REFERENCE TO RELATED APPLICATIONS

This is a utility patent application being filed in the United States as a non-provisional application for patent under Title 35 U.S.C. § 100 et seq. and 37 C.F.R. § 1.53(b) and, claiming the benefit of the prior filing date under Title 35, U.S.C. § 119(e) of the United States provisional application for patent that was filed on Nov. 22, 2021 and assigned Ser. No. 63/281,964, which application is incorporated herein by reference in its entirety.

### BACKGROUND

An augmented reality headset (ARHS) is a type of wearable display apparatus where the viewer is able to see both virtual, computer-generated images and the physical world. For this reason such devices are sometimes known as see-through head-mounted displays (HMDs).

One of the key components of an ARHS is the eyepiece, or combiner, the optical element which steers the light from the computer-generated images so that it is overlaid on top of the transmitted image from the physical world. In most embodiments, the combiner serves to act as a tilted, partially-reflecting mirror which deflects a portion of the light from the virtual image to the wearer's eye while also allowing a portion of the light from the physical world to be transmitted to the wearer's eye.

A number of technologies can be used to implement this tilted mirror. Some methods use a large, partially-silvered reflector, which can be flat or curved. Such a system is easy to design and fabricate, but suffers from geometric and ergonomic considerations which severely detract from its practical viability. Some systems use a series of flat and curved reflectors and lenses, allowing for a more compact form factor. However, realizing such a system requires multiple cascaded partial reflectors and polarization optics, which reduce the brightness of the transmitted, physical image to a point where the user experience is negatively affected. Yet other systems use a holographic element to reflect and focus light from a small projection engine mounted at the side of the wearer's head into the wearer's eye, but such a system exhibits a limited field of view (FOV). Another popular system uses a thin waveguide with a diffraction grating that redirects light to the wearer's eye, but the diffraction grating causes color dispersion of the transmitted image which prevents usage in bright conditions.

The present invention describes an advancement to the last system which uses a much thicker lightguide with physical tilted mirrors embedded inside the lightguide that redirect the image light to the wearer's eye. Such a system presents a number of advantages: it eliminates the fabrication of a large area diffraction grating with precisely controlled blaze angle and groove spacing, it eliminates color dispersion in the transmitted image as well as color dispersion in the virtual image, and it can be made to be highly efficient with a large field of view. However, with regard to such a system, the current state of the art poses several challenges regarding assembly of the lightguide, fabrication of the embedded mirrors, and the presence of ghost and secondary images.

It is evident that improvements on the performance and manufacturability of such a lightguide eyepiece would facilitate its use and thereby advance the state of ARHS optical systems as a whole.

### BRIEF SUMMARY

The present disclosure is related to augmented reality headset (ARHS) eyepieces, and more precisely, a lightguide type ARHS eyepiece having one or more dimensions much thicker than one wavelength of visible light with one or more embedded reflectors. In some embodiments the eyepiece consists of a laminated set of optically transparent layers; in other embodiments the eyepiece consists of a single outcoupling region made of an optically transparent material. A method for fabricating such an eyepiece and additional uses of such apparatus are also included in the disclosure.

### BRIEF DESCRIPTION OF THE SEVERAL VIEWS OF THE DRAWING

FIG. 1 depicts an augmented reality headset (ARHS)

FIG. 2 depicts an embodiment of an ARHS optical system using a large partial reflector

FIG. 3 depicts an embodiment of an ARHS optical system using a reflective/refractive system

FIG. 4 depicts an embodiment of an ARHS optical system using a reflective hologram

FIG. 5 depicts an embodiment of an ARHS optical system using a diffraction grating

FIG. 6 depicts a lightguide

FIG. 7 depicts an embodiment of an ARHS optical system using a lightguide eyepiece

FIG. 8 depicts a lightguide eyepiece having sparse reflectors embedded within

FIG. 9 depicts a lightguide eyepiece having multiple partially reflecting mirrors embedded within

FIG. 10 depicts a lightguide eyepiece built as a laminated stack of optically transparent elements

FIG. 11 depicts a secondary image path from a lightguide eyepiece

FIG. 12 depicts another secondary image path from a lightguide eyepiece

FIG. 13 depicts the key tolerances of a lightguide eyepiece fabricated as a laminated stack of pieces

FIG. 14 depicts one method to fabricate a lightguide eyepiece as a laminated stack of pieces

FIG. 15 depicts methods to remove excess adhesive from a completed lightguide eyepiece as fabricated in FIG. 14

FIG. 16 depicts another method to fabricate a lightguide eyepiece as a laminated stack of pieces

FIG. 17 depicts further enhancements to the fabrication of a lightguide eyepiece

FIG. 18 depicts another way to fabricate a lightguide eyepiece

FIG. 19 depicts another way to fabricate a lightguide eyepiece

FIG. 20 depicts another way to fabricate a lightguide eyepiece

FIG. 21 depicts uses of a lightguide in an ARHS, other than as an eyepiece

### DETAILED DESCRIPTION OF VARIOUS EMBODIMENTS

The present invention, as well as features and aspects thereof, is directed towards providing an ARHS optical system using two or more lightguides. In some embodiments, one or more lightguides are used in the projection system to couple light into one or more lightguides. The lightguides act as eyepieces and redirect light to the wearer's eye. In some embodiments, one or more lightguides in the projection system are used to replicate the pupil of the projection system if one axis, and the lightguides which act as eyepieces use a sparse distribution of small mirrors to redirect light to the wearer's eye. Further, the present invention is directed towards a lightguide augmented reality eyepiece utilizing a sparse distribution of small mirrors as the out-coupling element and constructed as a laminated stack of one or more elements. In some embodiments, the dimensions of the small mirrors may be between 0.1 mm and 3 mm. The light from a display source propagates by total internal reflection. These and other embodiments, features, aspects, advantages, etc. are described herein below with reference to the drawings.

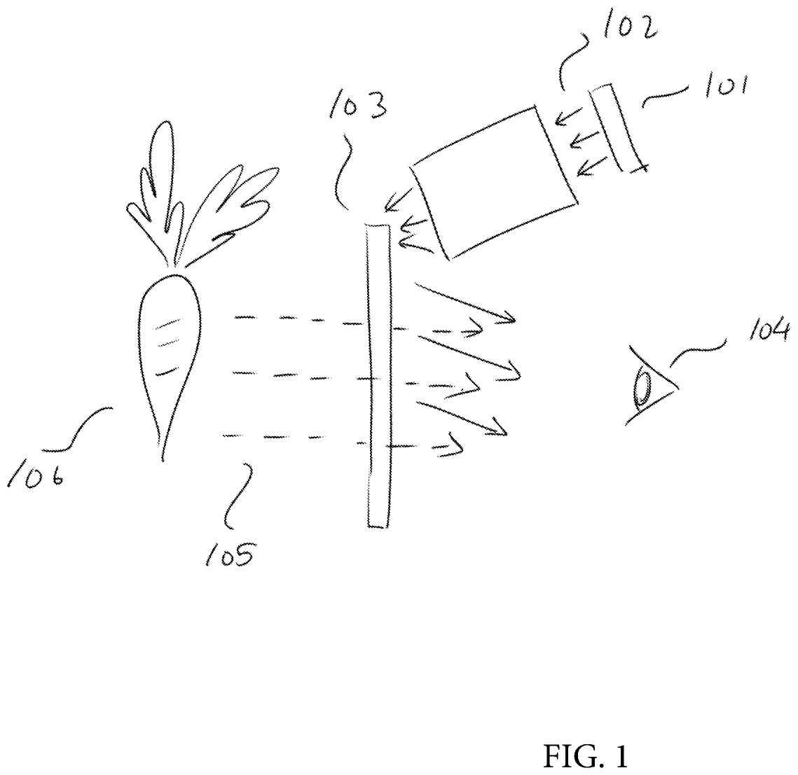

FIG. 1 depicts the optical path of an augmented reality headset (ARHS). A digital display 101 connected to a computing device displays a virtual image, the light 102 of which is transmitted through a projection module consisting of several (possibly zero) optical elements onto a eyepiece or combiner 103. The combiner redirects a portion of the light 102 into the wearer 104's eye, while also letting a portion of the light 105 from real objects 106 in the wearer's environment be transmitted to the wearer's eye. The overall effect is as if virtual images on the display generated by the computing device are placed in the wearer's environment.

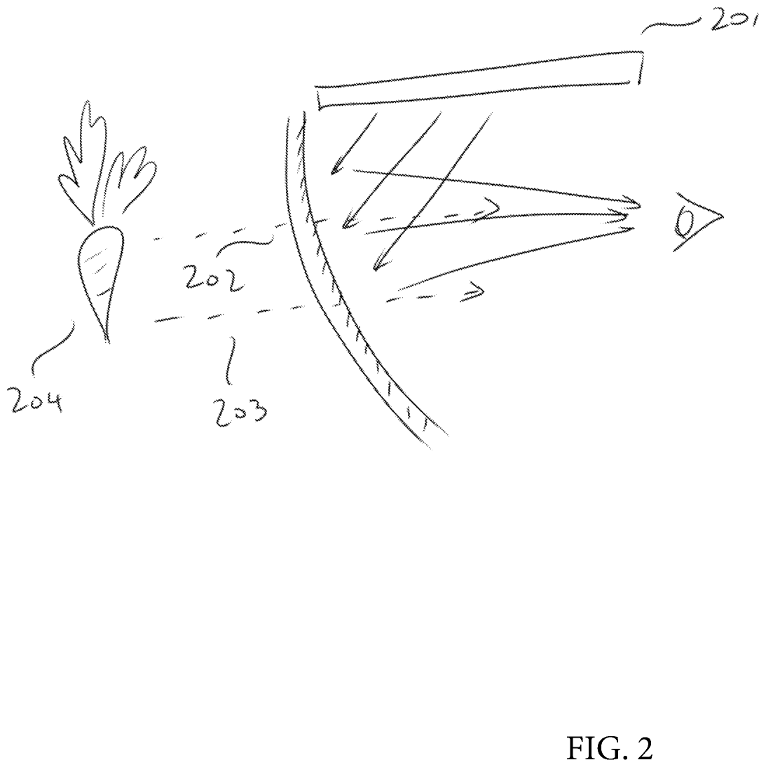

FIG. 2 depicts one embodiment of the eyepiece or combiner in which the light emitted by the display 201 is reflected from the curved, partially silvered reflector 202 to the wearer's eye. Either the front or back surface of the reflector is silvered, with the other being transparent, and the overall thickness and curvature of the two surfaces is such that the light 203 from objects 204 in the wearer's environment is transmitted undistorted to the wearer's eye.

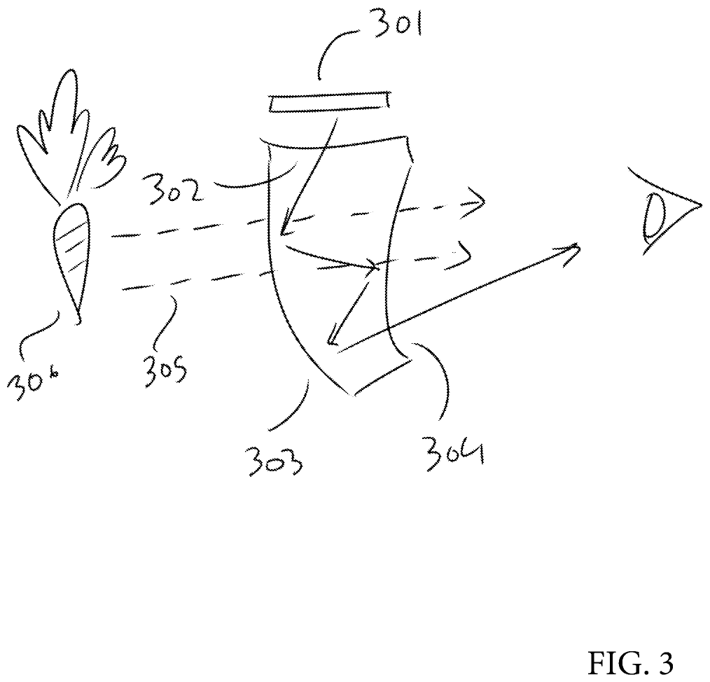

FIG. 3 depicts another embodiment of the eyepiece or combiner in which light emitted by the display 301 is reflected and refracted several times through a series of optically powered surfaces 302, 303, 304, which, in some embodiments, are the surfaces of one or more optical prisms placed in front of the wearer's eye. This system allows for the generation of a large field of view (FOV) by magnifying a smaller display while allowing light 305 from objects 306 in the wearer's environment to be transmitted undistorted to the wearer's eye.

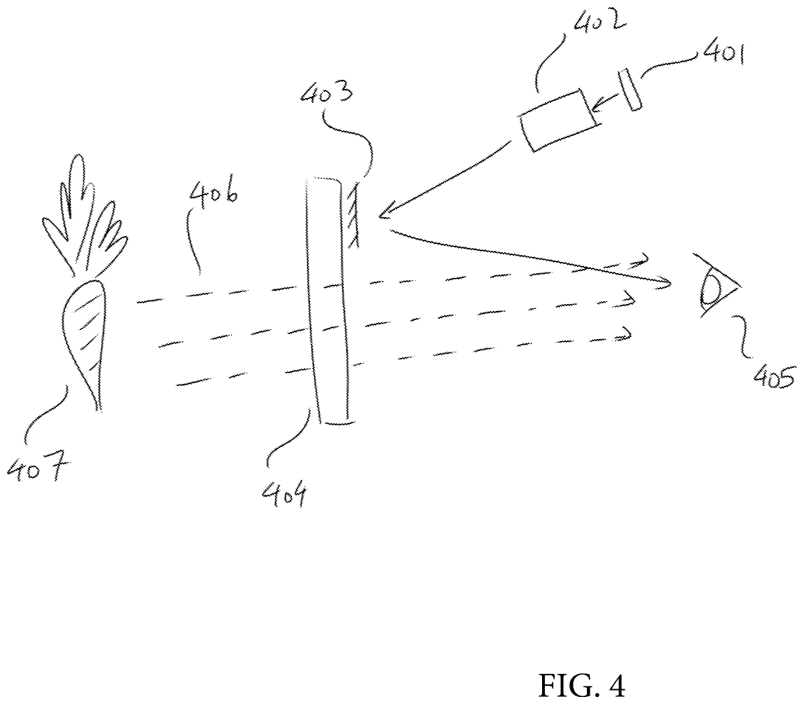

FIG. 4 depicts another embodiment of the eyepiece or combiner in which light emitted by the display 401, which in some embodiments is a temporally interlaced laser scanning system, is transmitted and/or reflected by a projection system 402 having zero or more elements before reflecting off of a hologram 403 on a eyewear lens 404 (which, in some embodiments is a prescription eyeglass lens). This hologram acts as a optically powered elements which redirects and focuses light to the wearer's eye 405; the mostly clear aperture of the eyewear lens allows light 406 from objects 407 in the wearer's environment to be transmitted undistorted to the wearer's eye.

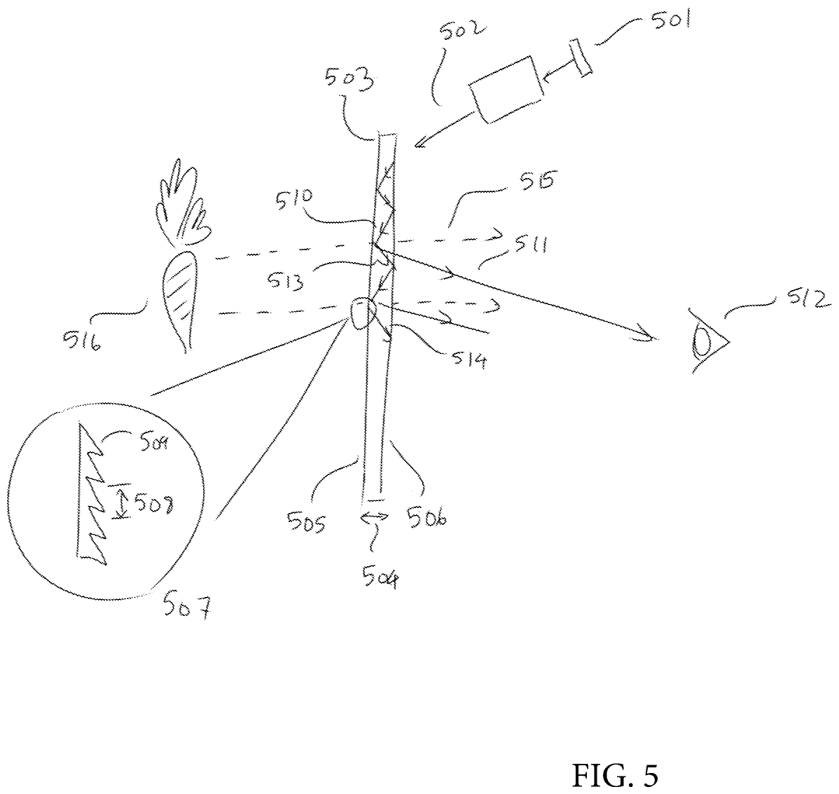

FIG. 5 depicts another embodiment of the eyepiece or combiner in which light 502 emitted by the display 501, which is some embodiments is a temporally interlaced laser scanning system and in some embodiments is a micro-projector utilizing a OLED, inorganic LED, liquid crystal, LCOS, or DMD microdisplay, is transmitted and/or reflected by a projection system having zero or more elements before being coupled into the thin waveguide 503 which has a thickness 504 comparable to one wavelength of visible light. The material of the waveguide has a higher refractive index than the surrounding air and therefore the light is confined to the propagation modes of this waveguide. One or both of the surfaces 505 and 506 of this waveguide has a nano-structured diffraction grating (detail 507) affixed to it. In some embodiments this grating is a blazed grating; in other embodiments it could be a complex metasurface. The pitch or spacing 508 of individual elements 509 of this grating is equal to or less than a wavelength of visible light. The interaction between the propagating light 510 and the diffraction grating redirects some of the light 511 in such a way that it leaks from the waveguide and enters the wearer's eye 512. Some of the propagating light 513 is redirected in a way that does not enter the viewer's eye; the remainder of the light 514 continues through the waveguide and is subsequently redirected by further interaction with the diffraction grating. Transmitted light 515 from objects 516 in the viewer's environment passes through the diffraction grating where based on the wavelength of the transmitted light, it gets diffracted at different angles.

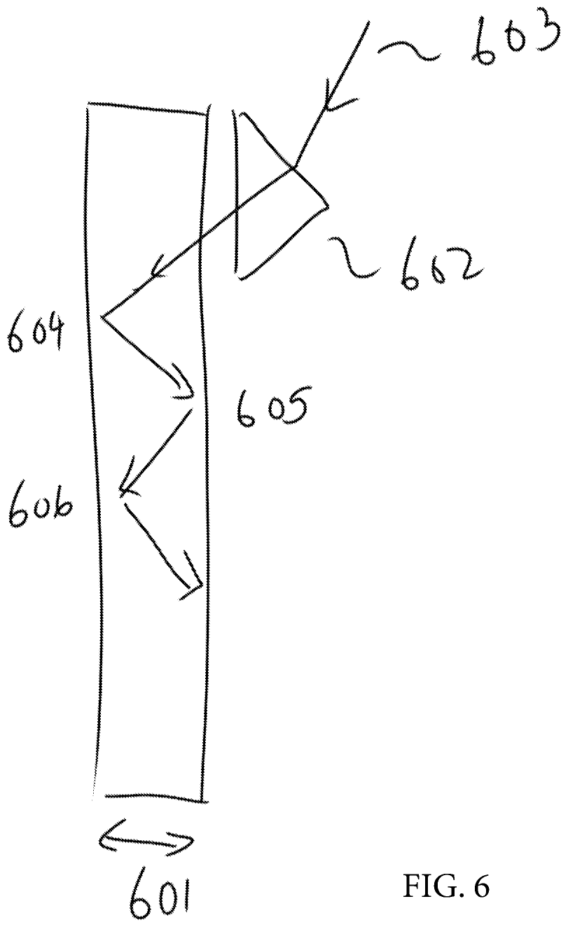

FIG. 6 depicts a lightguide. A lightguide is similar to a waveguide, with the exception that the dimensions 601 are all much larger than a wavelength of light; for example, 1 mm or more. A coupling element 602 injects light 603 into the body of the lightguide where it is confined by total internal reflection 604, 605, 606 and propagates inside the lightguide. The behavior of the lightguide can be analyzed in the geometric regime.

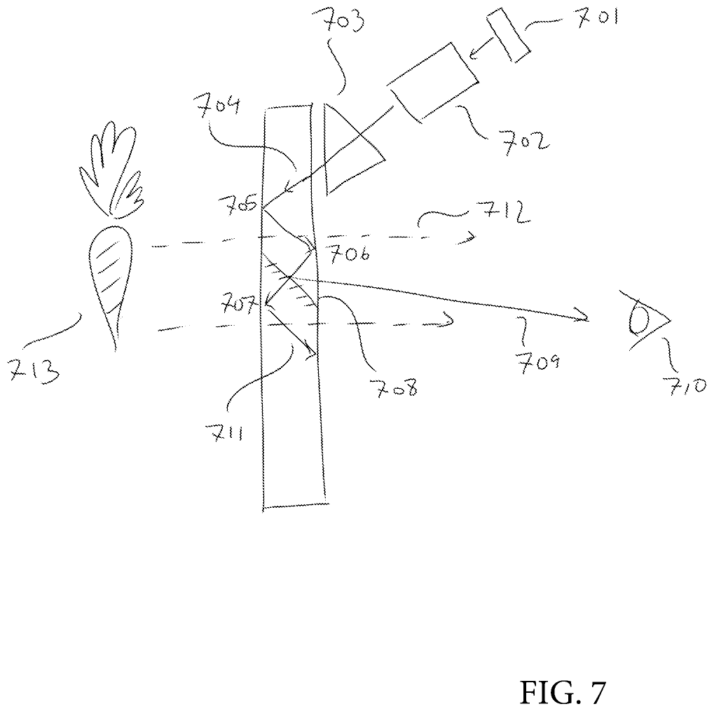

FIG. 7 depicts another embodiment of the eyepiece or combiner in which light emitted by the display 701 which is some embodiments is a temporally interlaced laser scanning system and in some embodiments is a micro-projector utilizing a OLED, inorganic LED, liquid crystal, LCOS, or DMD microdisplay, is transmitted and/or reflected by a projection system 702 having zero or more elements before entering the coupling element 703 which in some embodiments is a diffraction grating and in some embodiments is a refracting prism. The coupling element injects light 704 from the display into the lightguide where it is confined by total internal reflection 705, 706, 707. As the light propagates through the lightguide it encounters one or more slanted mirrors 708 which are arranged to allow a portion 709 of the propagating light to be redirected to the wearer's eye 710, and allows a portion 711 of the propagating light to continue to propagate through the lightguide. The slanted mirrors are also arranged in a way which allows transmitted light 712 from objects 713 in the wearer's environment to reach the viewer's eye.

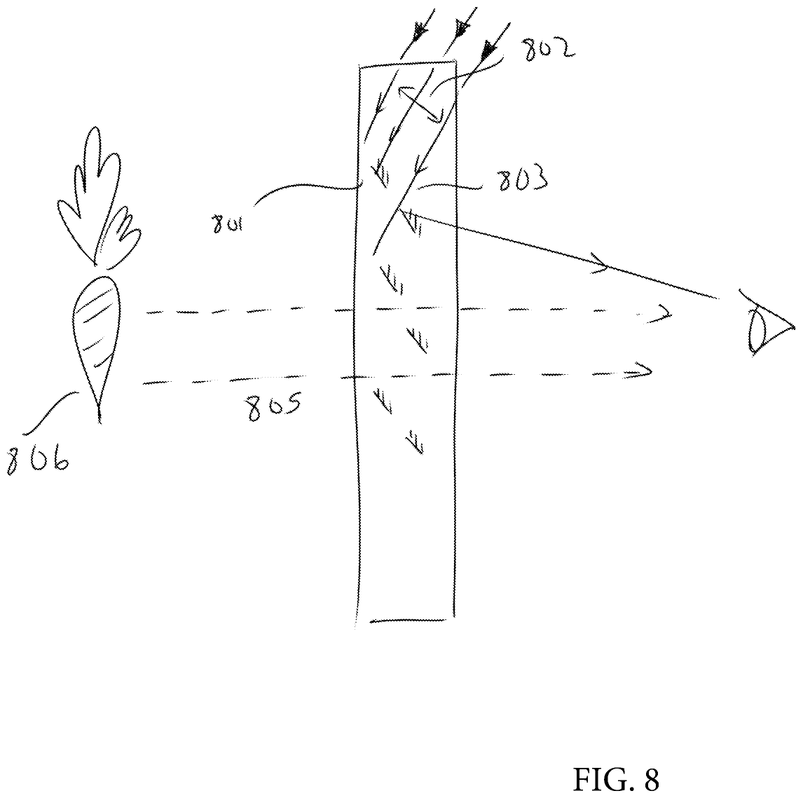

FIG. 8 depicts one embodiment of a lightguide eyepiece in which the slanted mirrors are arranged as a sparse distribution of small mirrors 801 with dimensions on the order of 1 mm such that the propagating beam of light 802 has dimension larger than that of the slanted mirror. In some embodiments, these mirrors are fully reflective mirrors across the operating wavelengths of the eyepiece. In other embodiments, these mirrors are a special coating, for example, but not limited to, a multi-band dielectric mirror, a holographic mirror, a polarization-sensitive coating, or a nano-structured coating. As the light propagates through the lightguide it encounters mirrors which redirect a small portion 803 of the light to the wearer's eye 804, while allowing the remaining portion of light to continue propagating. Similarly, light 805 from objects 806 in the wearer's environment is allowed to transmit through the gaps between the mirrors in an undistorted fashion.

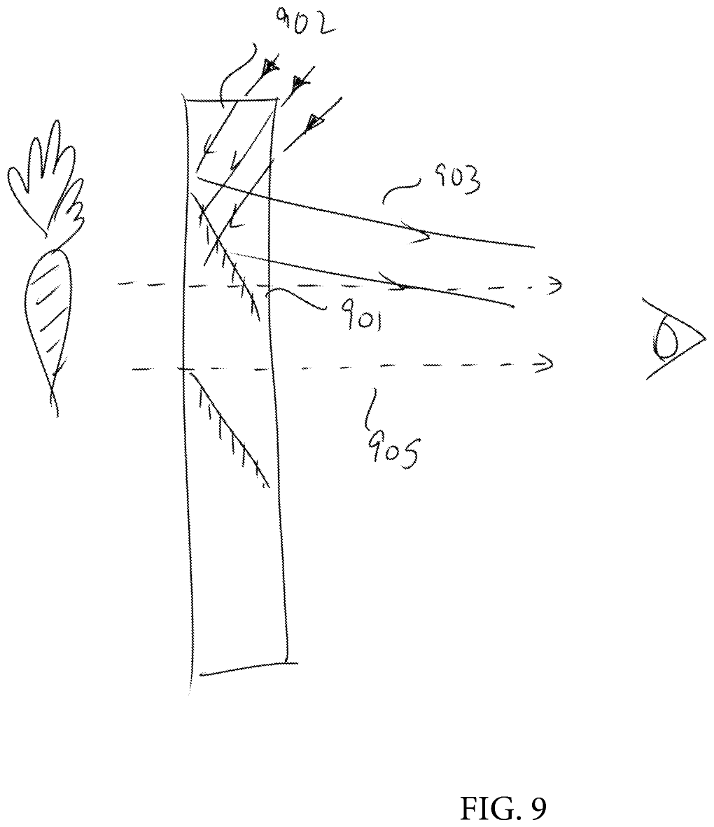

FIG. 9 depicts another embodiment of a lightguide eyepiece in which the slanted mirrors are arranged as one or more large, partially reflective mirrors 901 with dimensions similar to those of the propagating beam of light 902. In some embodiments, these mirrors are partially reflective silver mirrors. In other embodiments, these mirrors are a special coating, for example, but not limited to, a a multi-band dielectric mirror, a holographic mirror, a polarization-sensitive coating, or a nano-structured coating. As light propagates through the lightguide it encounters mirrors which reflect a fraction of the power in the beam 902 to the beam 903 which reaches the wearer's eye 904 while allowing the remaining power to continue propagating. Light 905 from objects 906 in the wearer's environment is partially transmitted through the partially reflecting mirrors and allowed to reach the wearer's eye in an undistorted fashion.

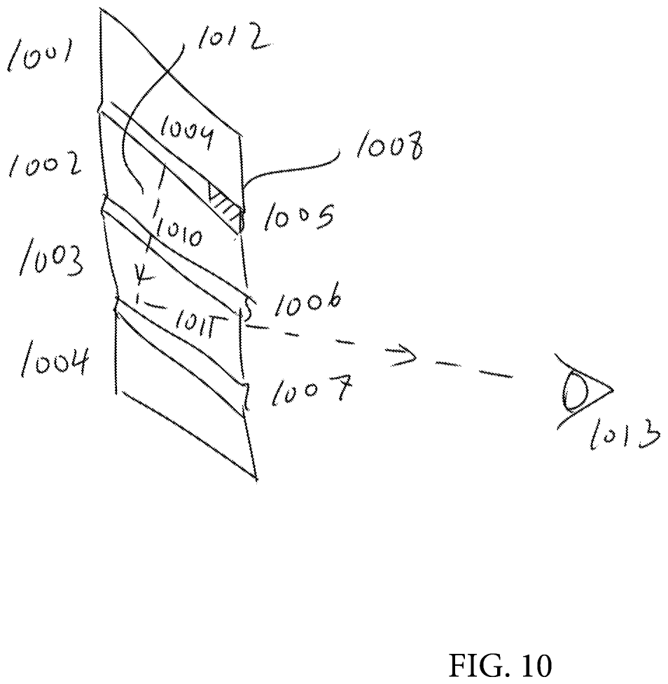

FIG. 10 depicts a realization of a lightguide eyepiece as a laminated stack of optically transparent elements. Elements 1001, 1002, 1003, 1004 are affixed to each other with layers of adhesive 1005, 1006, 1007. The number of elements and layers is exemplary; in some embodiments, there are only one or two layers. In some embodiments the adhesive is a thermally, chemically, or optically cured epoxy resin; in other embodiments the bond could be achieved as an optical contact between two clean surfaces. In some embodiments the layer of adhesive is thin (below 10 micrometers). In other embodiments the layer of adhesive has thickness over 10 micrometers and there are shims 1008 which constrain the positioning of the individual elements. The surfaces 1009, 1010, 1011 are slanted surfaces which have reflective coatings on them. In some embodiments, these coatings are sparse arrays of small mirrors as depicted in FIG. 8; in other embodiments these coatings are partially reflective large mirrors as depicted in FIG. 9. In some embodiments the slanted surfaces 1009, 1010, and 1011 may not be planar surfaces, but rather could be spherical, cylindrical, aspherical, or free-form optical surfaces with specifications as determined by the requirements of the ARHS which incorporates the eyepiece. In other embodiments, surfaces 1009, 1010, and 1011 may be Fresnel or kinoform surfaces with specifications as determined by the requirements of the ARHS which incorporates the eyepiece. In either case, the requirements for the specifications of theses surfaces can be determined through an optimization process incorporating both the structure of the eyepiece and the design of the ARHS system which maximizes some weighted combination of image quality metrics and system metrics including, but not limited to, modulation transfer function (MTF), distortion, contrast, size, and component cost. Propagating light 1012 reflects from the side of the mirror in contact with the optical substrate and is redirected to the wearer's eye 1013.

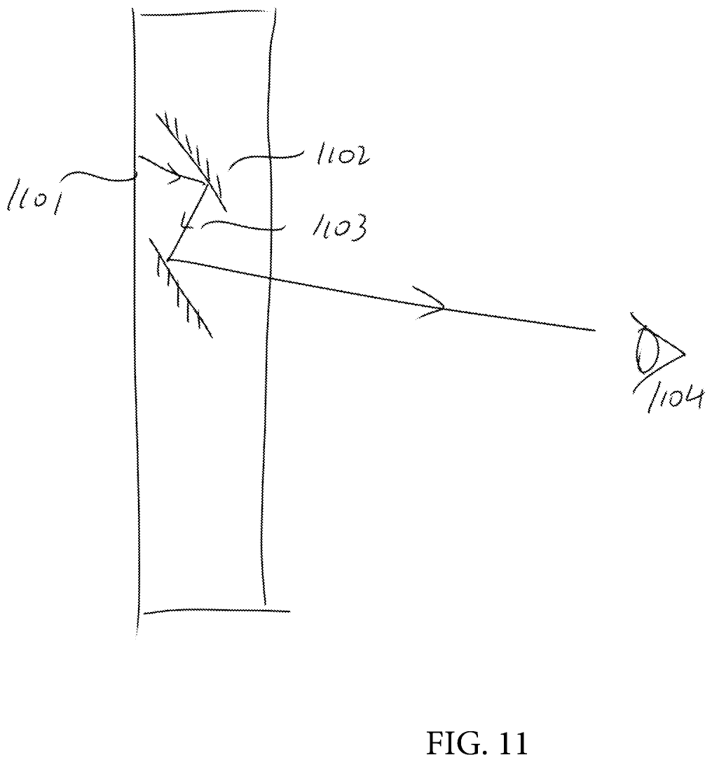

Such a lightguide eyepiece has several potential paths for secondary images. FIG. 11 depicts one of them. Propagating light 1101 strikes the backside of a slanted mirror 1102, and is deflected to a different path. The light propagates along this path 1103 until it encounters another slanted mirror and is coupled into the wearer's eye 1104. This secondary image path can be eliminated by using a sparse array of small mirrors as in FIG. 8 and applying a non-reflective coating to the backside of these mirrors. In some embodiments this coating is a layer of black paint or pigment which is applied using a brush, spray apparatus, or electrostatic coating process. In some embodiments this is an engineered coating which is applied using a physical vapor deposition process such as sputter coating or evaporation. In yet other embodiments this is a structured coating or layered dielectric coating which is wavelength selective or angle selective and allows for the transmission, rather than reflection, of this light path.

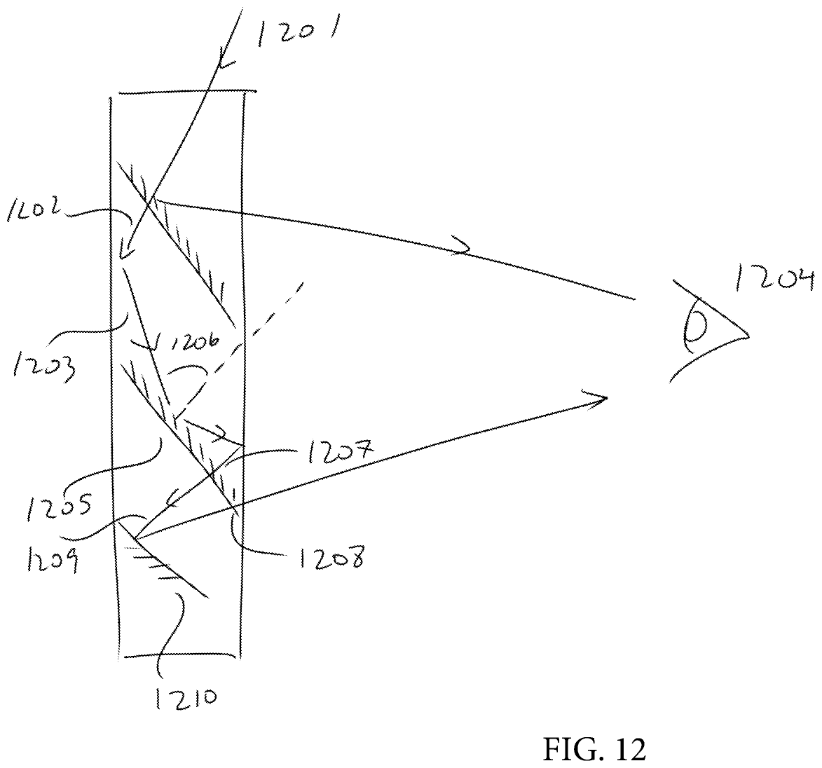

FIG. 12 depicts another path that forms a secondary image. Propagating light 1201 can travel in two directions (1202, 1203). One direction 1202 is deflected into the wearer's eye 1204. The other direction intersects the adhesive interface 1205 at a grazing angle 1206. For large fields of view, angle 1206 can be over 75 degrees. Because the critical angle for total internal reflection (TIR) varies non-linearly with the difference in refractive indexes on the two sides 1207 and 1208 of the interface, at high values of angle 1206 even a small difference in refractive index can cause total internal reflection at the interface, resulting in the deflected light path 1209. Light path 1209 cannot reach the wearer's eye, but it can strike an slanted outcoupling mirror 1210 to reach the wearer's eye.

The present invention eliminates the secondary image paths depicted in FIG. 12 by selecting properties of the transparent lightguide material and the adhesive at the interface to meet several criteria. First, the nominal index of refraction of the adhesive is chosen to be greater than the nominal index of refraction of the lightguide material. Second, the dispersion characteristics of the two materials are matched in such a way that the index of refraction of the adhesive is greater than the index of refraction of the lightguide material through the entire operating wavelength range of the lightguide. Third, the index of refraction of the adhesive is not much higher than that of the lightguide material such that the partial reflection at the interface creates an excessively bright secondary image, for example, 0.02 or less throughout the entire operating wavelength range.

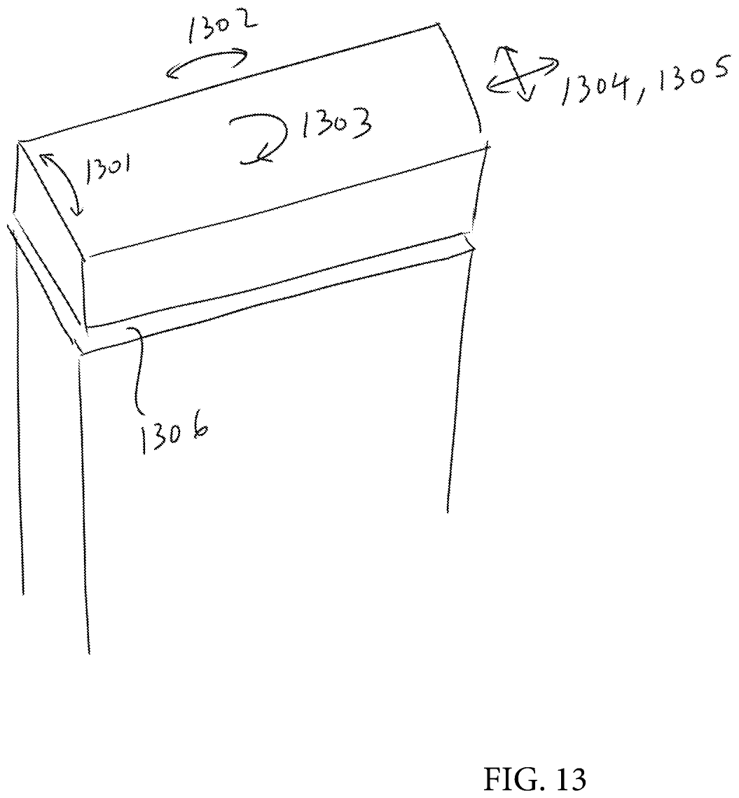

The present invention includes special manufacturing methods that are required to meet the specified tolerances of the lightguide in order to maximize clarity and sharpness, uniformity, and contrast in the projected image. FIG. 13 depicts some of the key tolerances which determine the as-built performance of the apparatus. 1301 and 1302, the relative pitch and yaw of the layers, determine the overlay accuracy of the individual sub-images projected by each layer piece. In order for these individual sub-images to overlay correctly to form a high-resolution image with no image blur, the angles 1301 and 1302 are chosen to be under one-half (ideally, one-quarter) of the angle subtended by a single image pixel. The relative roll 1303 and the translational offsets 1304, 1305 are constrained to achieve suitable image quality; for example to achieve sufficient image uniformity of the lightguide for certain embodiments, for example in the embodiment where the out-coupling elements are sparse arrays of slanted mirrors. The roll 1303 and offsets 1304, 1305 are also constrained to achieve suitable flatness of the front and back faces of the lightguide and therefore constrain the optical path of the light guided within the lightguide to within design tolerances. The bond-line thickness 1306 is constrained such that the total optical path length of light traveling in the lightguide is within design tolerances as well as to ensure certain material properties of the adhesive are within design tolerances.

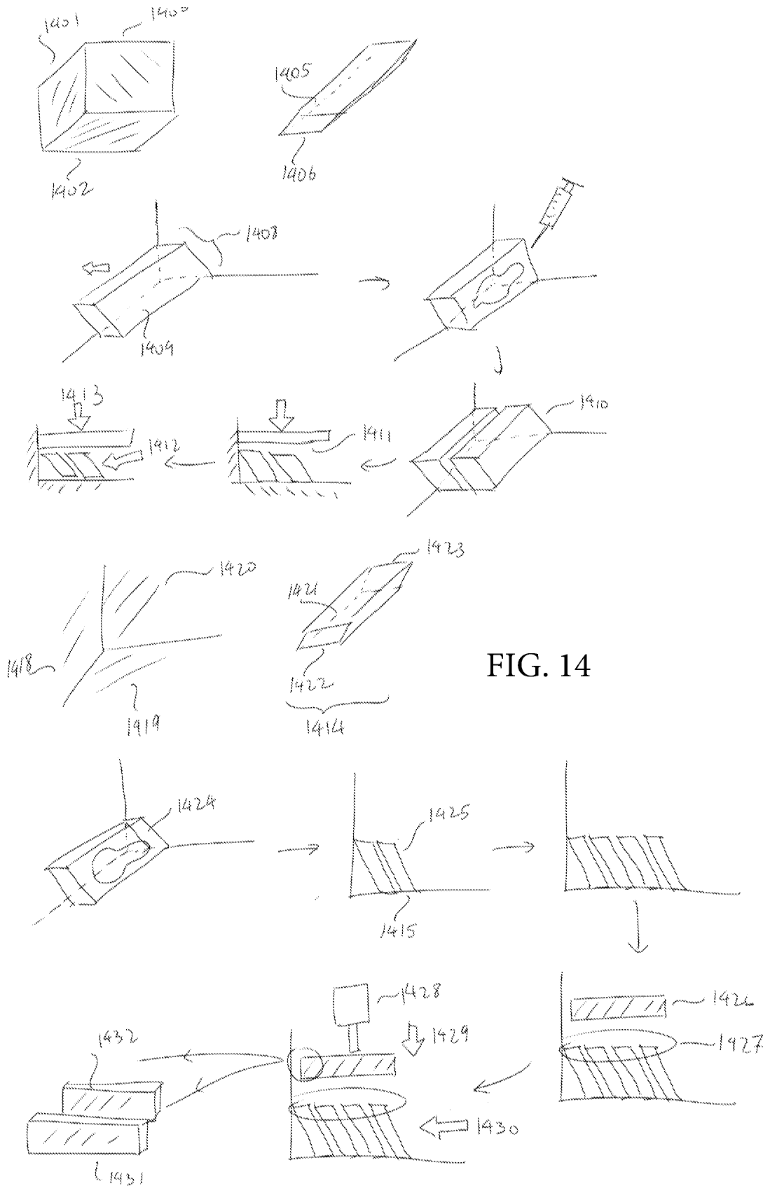

FIG. 14 depicts one method of manufacturing a lightguide to appropriate tolerances. Surfaces 1401, 1402, and 1403 are precision flat faces which are orthogonal to each other. In some embodiments these are the three faces of precision ground machinist's block(s), in other embodiments these are the three faces of a single precision ground component, for example fabricated from low-expansion glass ceramic. Each piece (example 1404) is precision ground so that edge 1405, face 1406, and face 1407 are orthogonal to each other. The first piece 1408 is placed on surface 1402 and abutted against face 1401. A quantity of optically clear adhesive, for example, heat-cure, UV-cure, or epoxy resin, with an index of refraction greater than the index of refraction of the lightguide material is deposited onto the face 1409 of piece 1408. The quantity of this adhesive is controlled using a precise dosing mechanism (for example a constant-volume pneumatic syringe dispenser) such that the volume of adhesive is somewhat greater than the volume of the intended bond-line so as to eliminate air bubbles in the final bond line. This allows the thickness of the bond-line to be controlled. A subsequent piece 1410 is placed such that it is abutted against surfaces 1402 and 1403, and in contact with the adhesive on face 1409. Surface 1411, which is coated with an adhesive release compound, is brought down and aligned against the flat top faces of the assembly to constrain the roll of the pieces. Precise forces (for example, exerted by pneumatic, hydraulic, or electromechanical actuators) 1412 and 1413 are exerted against the newly added piece and surface 1411, respectively, such that the bond line is compressed to the appropriate thickness based on material properties of the adhesive. In some embodiments, the adhesive is cured with the appropriate method after the addition of each piece part. In other embodiments, the entire assembled lightguide is cured after all piece parts are placed. In another method to manufacture the lightguide, pieces 1414, 1415, 1416, and 1417 are placed against precision flat faces 1418, 1419, and 1420 which are orthogonal to each other. In some embodiments these are the three faces of precision ground machinist's block(s), in other embodiments these are the three faces of a single precision ground component, for example fabricated from low-expansion glass ceramic. Each piece (example 1414) is precision ground so that edge 1421, face 1422, and face 1423 are orthogonal to each other. The number of pieces is exemplary and need not be 4; it could be two or three. The first piece 1414 is placed on surface 1419 and abutted against surface 1418. A quantity of optically clear adhesive, for example, heat-cure, UV-cure, or epoxy resin, with an index of refraction greater than the index of refraction of the lightguide material is deposited onto the face 1424 of piece 1414. A subsequent piece 1415 is placed such that it is abutted against surfaces 1419 and 1420, and in contact with the adhesive on face 1424. Adhesive is subsequently deposited on face 1425 of piece 1415, and the process is repeated for parts 1416 and 1417. Subsequently, the precision flat surface 1426 is brought down to abut against the top face 1427 (opposite to surface 1419) of the piece assembly and an actuator 1428, for example, a hydraulic or pneumatic cylinder or electric actuator, applies a force 1429 to surface 1426 of a precise amount such that the pieces self-level and align to the precision flat surface 1419. The precise force and profile of force over time are selected to optimize the self-leveling of the pieces. The force 1429 is then increased and force 1430 is applied to piece 1417 such that the bond-lines are compressed to minimal thickness. The ratio of the magnitudes of forces 1429 and 1430 are selected to minimize bond-line thickness while insuring, in some cases, the lever action of force 1430 in the upward direction does not exceed the magnitude of force 1429, which would disrupt the flatness of the assembled lightguide. In some embodiments where the adhesive is a UV-cure adhesive, the flat surface 1426 is not a continuous surface, but consists of two precision ground contact lines 1431 and 1432 of a width (for example, 3-6 millimeters) selected to apply sufficient uniform pressure to face 1427, but not so wide as to obscure the face and prevent curing of the adhesive.

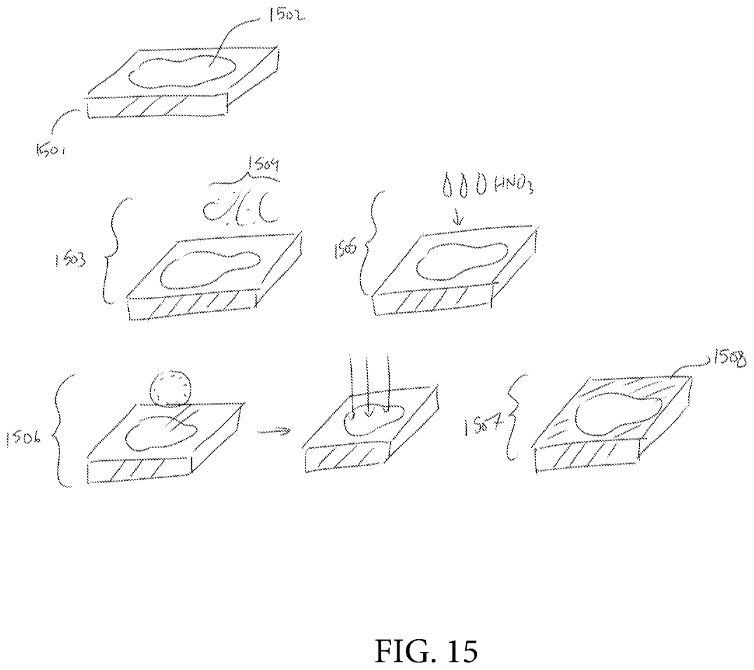

FIG. 15 depicts the assembled lightguide immediately after the steps in FIG. 14. The optically transparent lightguide 1501 is embedded in a quantity of excess cured adhesive 1502. There are several methods to remove this excess adhesive. 1503 depicts one method where a powder-blasting process utilizing an abrasive powder 1504 which is harder than the cured adhesive and softer than the lightguide material is used to remove the cured adhesive. 1505 depicts another method where a wet etching process using, for example, hot nitric acid is used to preferentially dissolve the cured adhesive without damaging the inorganic lightguide material. 1506 depicts another method where the bulk of the cured adhesive is ground or milled away leaving a thin layer over the entire lightguide, after which a dry etching process which is selective for the cured adhesive is used to remove the remainder. 1507 depicts yet another method whereby the lightguide piece parts are coated with a release material 1508 (for example, a metal coating). Subsequently, the release material is etched with a selective process which does not damage the lightguide material to release the excess adhesive from the completed lightguide. This allows for the lightguide material and adhesive to be similar classes of material; for example, a lightguide which is fabricated from a castable or injection-moldable polymer resin.

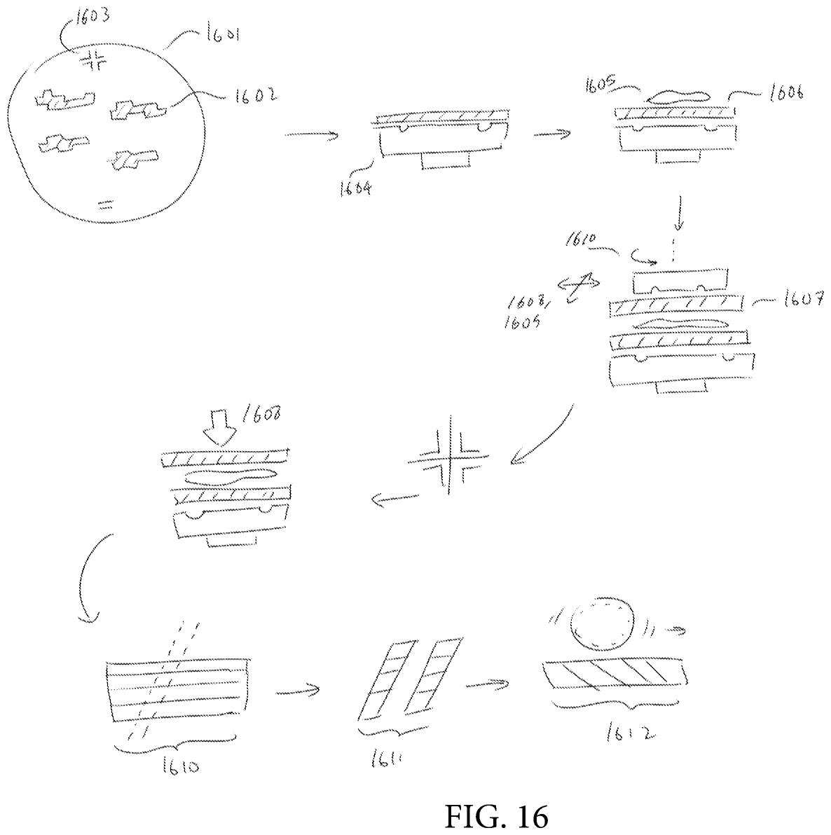

FIG. 16 depicts another method of manufacturing a lightguide to appropriate tolerances. Precision ground, thin flats of the appropriate lightguide material (“wafers”) 1601 are patterned with patterns 1602 corresponding to the distribution of the reflective mirrors. Also present in the pattern are alignment fiducials 1603. The linear dimensions of the wafer can be much larger than the size of each of the lightguide piece parts. The first wafer is affixed to a chuck or a holder 1604 with for example a light adhesive or vacuum force. A quantity of optically clear adhesive 1605, for example, heat-cure, UV-cure, or epoxy resin, with an index of refraction greater than the index of refraction of the lightguide material is deposited onto the face 1606 of the first wafer. The quantity of this adhesive is controlled using a precise dosing mechanism (for example a constant-volume pneumatic syringe dispenser) such that the volume of adhesive is somewhat greater than the volume of the intended bond-line across the entirety of the wafer so as to eliminate air bubbles in the final bond line. A subsequent wafer 1607 is gripped (for example, with a vacuum chuck) with an actuated apparatus which can translate in directions 1608, 1609 and rotate about axis 1610. The fiducials on 1607 (which may be a different pattern of fiducials than those on 1603) are aligned to those on 1603. Subsequently, a uniform force 1608 is applied to wafer 1607 (for example, with a pneumatic, hydraulic, or electromechanical actuator, or a uniform volume of compressed air applying a known pressure) to compress the bond line to the desired thickness based on the material properties of the adhesive. The process is then repeated with the next wafer 1609. In some embodiments, the adhesive is cured with the appropriate method after the addition of each wafer. In other embodiments, the entire assembly is cured after all wafers are placed. The resulting assembly consists of a stack of wafers which are all parallel to each other which is then diced 1610 (using, for example, a diamond blade, a wire saw, or a laser) to create individual assemblies 1611 which are somewhat larger than the finished lightguide. A conventional polishing, lapping, or grinding process 1612 is used to polish the rough faces of the diced lightguide assembly to final specifications.

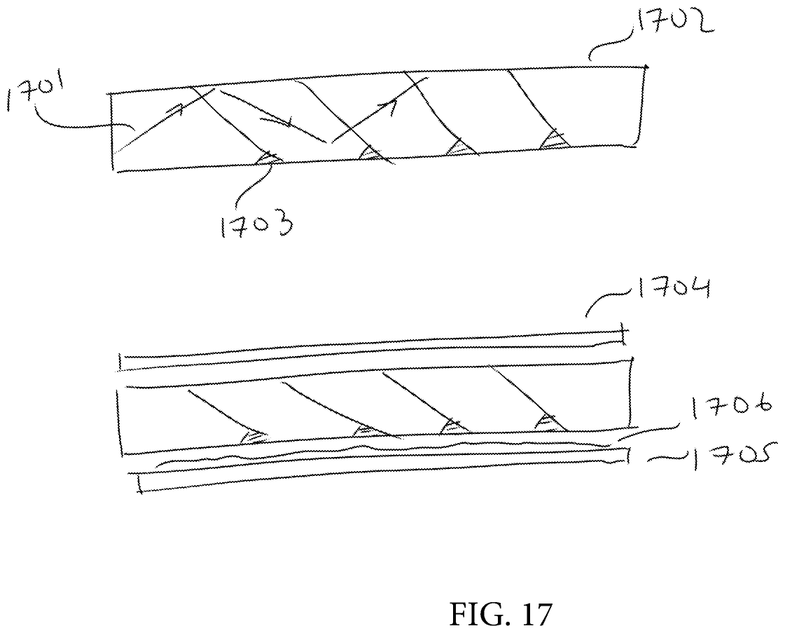

In the methods presented in FIG. 14, FIG. 15, and FIG. 16, the lightguide may have chips or edge damage at the interface between the individual layer pieces as depicted in FIG. 17. As propagating light 1701 travels through the lightguide 1702, image light may bleed out through the chip 1703, which can reduce image brightness, contrast, or sharpness. In order to prevent this, it is possible to lap, grind, or polish the completed lightguide to eliminate these chips. Another method to eliminate these chips is to bond cover layers 1704 and 1705 made of an optically transparent material with suitable specifications, for example, but not limited to, having index of refraction and dispersion characteristics suitably selected to be similar to the index of refraction and dispersion characteristics of the lightguide material so as to minimize stray light, aberrations, and distortion, with an adhesive 1706 with suitable specifications, for example, but not limited to, having index of refraction and dispersion characteristics suitably selected to be similar to the index of refraction and dispersion characteristics of the lightguide material so as to minimize stray light, aberrations, and distortion.

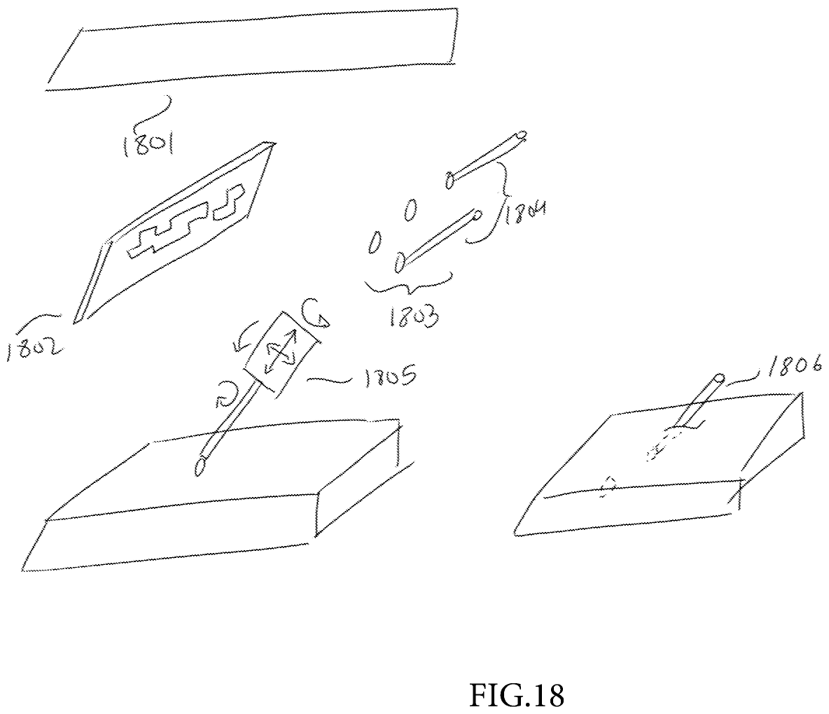

FIG. 18 depicts another method of manufacturing a lightguide to appropriate tolerances. A bulk optically transparent material is cast, polished, ground, and/or formed into a lightguide 1801 which is then placed in a viscous, soft, or liquid state. In some embodiments, this is a UV-cure, heat-cure, or epoxy resin which is in an uncured state. In other embodiments, this is an optically transparent polymer or glass material with a low glass transition temperature which is suitable for the following operations. Actuators 1805 are used to then place reflective mirrors in material. In some embodiments, these are optically transparent slides 1802 with suitable specifications, for example, but not limited to, having index of refraction and dispersion characteristics suitably selected to be similar to the index of refraction and dispersion characteristics of the lightguide material so as to minimize stray light, aberrations, and distortion, having coatings corresponding to the appropriate type of mirror. In other embodiments, these are individual small reflective mirrors 1803. In some embodiments, the mirrors are held on pieces of optically transparent material 1804 with suitable specifications, for example, but not limited to, having index of refraction and dispersion characteristics suitably selected to be similar to the index of refraction and dispersion characteristics of the lightguide material so as to minimize stray light, aberrations, and distortion. The lightguide material is then converted to a solid state, for example, by cooling, heat curing, catalytic action, or UV-curing, such that the reflective mirrors are frozen in place. In some embodiments, the reflective mirrors are first positioned with actuators in a negative mold, then viscous, soft, or liquid lightguide material is placed in the mold before being solidified. Polishing, grinding, lapping, or other forms of removal are used to then remove excess embedded material 1806 used to hold the mirrors to the actuators. The entire lightguide may then be polished, ground, or lapped to the appropriate final dimensions. In some embodiments patterns or fiducials placed in the lightguide are used to guide this process.

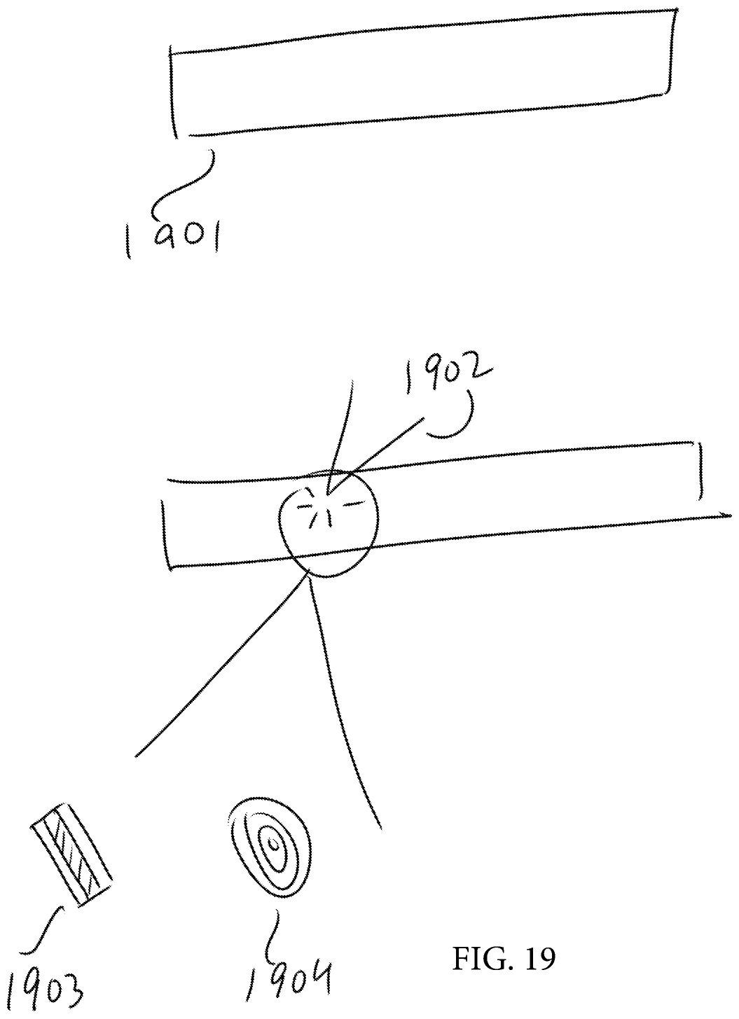

FIG. 19 depicts another method of manufacturing a lightguide to appropriate tolerances. A bulk optically transparent material is cast, polished, ground, and/or formed into a lightguide 1901. The material is selected such that the presence of an electric field permanently changes the refractive index of the material, and such that the magnitude of this change increase super-linearly with the magnitude of the electric field. A highly focused laser 1902 with high peak power, for example, a picosecond or femtosecond laser, is then scanned across the interior of the lightguide to precisely modify the index of refraction in a spatially varying fashion. In some embodiments, this is a infrared or visible light laser which generates blue or ultraviolet light through a two-photon interaction. The spatially varying index can be used to construct small mirrors, for example, but not limited to, Bragg reflectors 1903, or metamaterial surfaces with nanostructured optical power 1904.

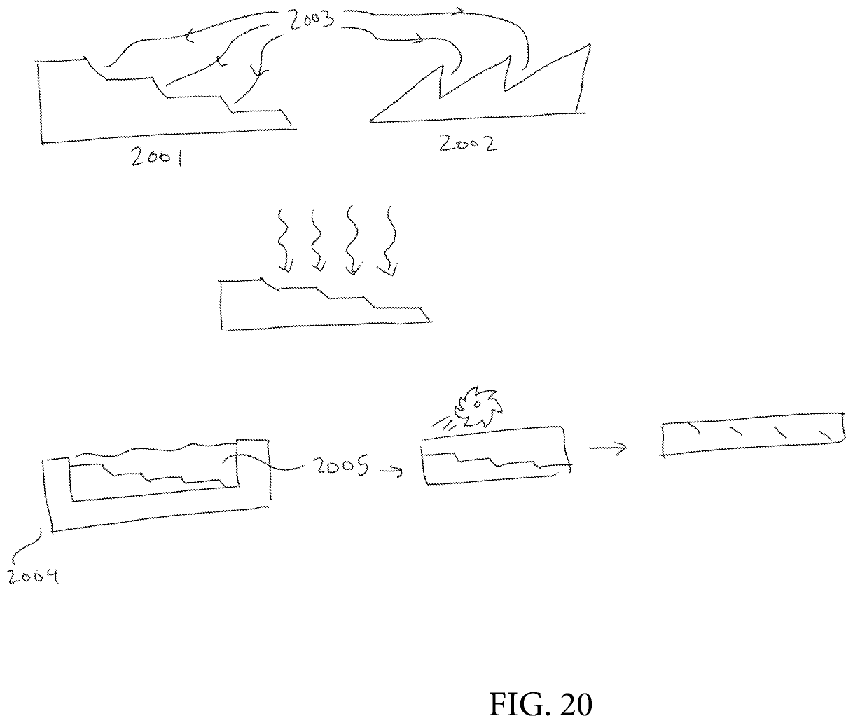

FIG. 20 depicts another method of manufacturing a lightguide to appropriate tolerances. A stair-step structure 2001 or alternatively, a sawtooth structure 2002 is cast, polished, ground, or formed from optically transparent material. A coating process is used to pattern mirrors onto the appropriate surfaces 2003 of the structure; in some embodiments these are fully reflective mirrors, in other embodiments they are a special coating, for example, but not limited to, a multi-band dielectric mirror, a holographic mirror, a polarization-sensitive coating, or a nano-structured coating. The structure is then placed in a mold 2004; optically transparent material 2005 in a viscous, soft, or liquid state, for example, UV-cure, heat-cure, or epoxy resin in an uncured state, is placed into the mold. This material has suitable specifications, for example, but not limited to, having index of refraction and dispersion characteristics suitably selected to be similar to the index of refraction and dispersion characteristics of the lightguide material so as to minimize stray light, aberrations, and distortion. The material is then converted to a solid state, for example, by cooling, heat curing, catalytic action, or UV-curing, and the entire assembly is removed from the mold. The entire lightguide may then be polished, ground, or lapped to the appropriate final dimensions. In some embodiments patterns or fiducials placed in the lightguide are used to guide this process.

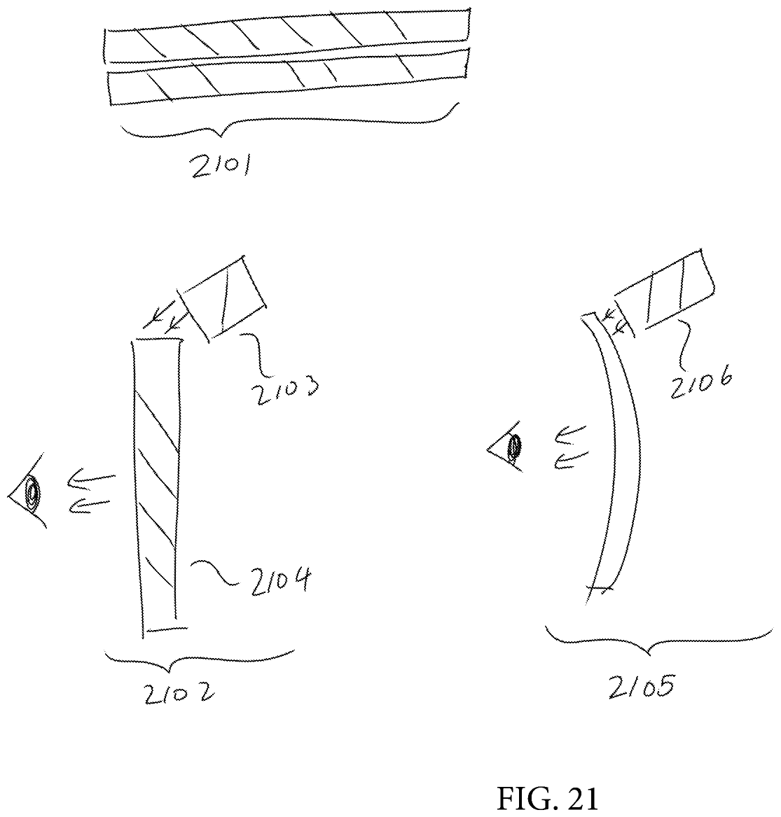

FIG. 21 depicts several other applications of a lightguide as described herein in an ARHS. In 2101, a modification to the eyepiece utilizes two or more lightguides with varying specifications. In some embodiments these lightguides use the same type of out-coupling mirror, in others these lightguides use different types of out-coupling mirror selected based on the requirements of the system. In 2102, one or more lightguides 2103 are used in the projection system, for example, to couple light into a lightguide eyepiece 2104 which consists of one or more lightguides acting to couple light to the viewer's eye. In 2105, one or more lightguides are used in the projection system to couple light into an eyepiece 2106 which is not a lightguide; in some embodiments this is a diffractive waveguide or holographic element. In some embodiments the lightguides 2103 or 2106 are used to perform pupil replication in one or more directions so as to increase the eye-box size of the ARHS.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art.

It will be appreciated by persons skilled in the art that the present invention is not limited by what has been particularly shown and described herein above. Rather the scope of the invention is defined by the claims that follow.

In the description and claims of the present application, each of the verbs, “comprise”, “include” and “have”, and conjugates thereof, are used to indicate that the object or objects of the verb are not necessarily a complete listing of members, components, elements, or parts of the subject or subjects of the verb.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art.

It will be appreciated by persons skilled in the art that the present invention is not limited by what has been particularly shown and described herein above. Rather the scope of the invention is defined by the claims that follow.

What is claimed is:

1. A lightguide augmented reality eyepiece utilizing a sparse distribution of small mirrors with dimensions between 0.1 mm and 3 mm as the out-coupling element, in which light from a display source propagates by total internal reflection, and constructed as a laminated stack of one or more elements.

2. The eyepiece of claim 1, wherein the adhesive used for the laminations has a nominal index of refraction greater than that of the lightguide material, the dispersion of the adhesive is such that the index of refraction of the adhesive is greater than that of the lightguide material across the operating wavelength range of the lightguide, and the index of refraction of the adhesive is sufficiently close to that of the lightguide material that any partial reflections at the adhesive interface do not create an excessively bright ghost image.

3. The eyepiece of claim 2, wherein the back sides of the small mirrors are coated with a light-absorbing material so as to suppress reflections from that side.

4. The eyepiece of claim 2, wherein the small mirrors are dielectric coatings on the transparent lightguide material such that light from the display source which strikes the back sides of the small mirrors is transmitted, rather than reflected.

5. The eyepiece of claim 1, wherein the laminated stack is realized as a stack of optically-contacted elements, with no adhesive.

6. The eyepiece of claim 1, wherein the eyepiece is fabricated by laminating individual piece-parts that have been fabricated and coated according to the tolerance and dimension specifications of the design.

7. The eyepiece of claim 4, wherein the eyepiece is fabricated using a jig which constrains the degrees of freedom using precision surfaces which have been placed so as to align the piece-parts according to the tolerance specifications of the design, and forces are applied to the piece parts according to the properties of the adhesive so as to align the parts to each other.

8. The eyepiece of claim 4, wherein an abrasive blasting process utilizing an abrasive which is softer than the transparent lightguide material but harder than the adhesive is used to remove excess adhesive after construction.

9. The eyepiece of claim 4, wherein a solvent-based process utilizing a solvent which preferentially dissolves the adhesive over the transparent lightguide material is used to remove excess adhesive after construction.

10. The eyepiece of claim 1, wherein the eyepiece is fabricated by laminating coated wafers of transparent material, having coatings corresponding to the sparse distribution of small mirrors, from which the resulting laminated structure is then cut and polished into individual eyepieces.

11. The eyepiece of claim 10, wherein an alignment apparatus being actuated in one or more axes is used to align fiducials which have been patterned onto the coated wafers.

12. The eyepiece of claim 4, wherein cover layers of optically transparent material having suitable specifications are bonded to the eyepiece with adhesive of suitable specifications so as to eliminate edge chips which may have occurred during the fabrication process.

13. The eyepiece of claim 10, wherein cover layers of optically transparent material having suitable specifications are bonded to the eyepiece with adhesive of suitable specifications so as to eliminate edge chips which may have occurred during the manufacturing process.

14. The eyepiece of claim 1, wherein the eyepiece is fabricated by using actuators to place small mirrors in a soft or liquid bulk material which is cast or molded to the appropriate specifications, which is then converted to a solid state through photochemical, thermal, or catalytic action.

15. The eyepiece of claim 1, wherein the eyepiece is fabricated by using a picosecond or femtosecond laser to modify the refractive index of a bulk transparent material so as to create Bragg reflectors, dielectric coatings, or metasurfaces having the action of small mirrors.

16. The eyepiece of claim 1, wherein the eyepiece is fabricated by creating a stair-step or sawtooth structure from an optically transparent material, coating said stair-step structure with coatings corresponding to the sparse distribution of small mirrors, then using optically transparent material with the appropriate specifications in a soft or liquid state to cast or mold the remainder of the eyepiece.

17. An ARHS optical system using two or more lightguides, wherein one or more lightguides are used in the projection system to couple light into one or more lightguides which act as eyepieces and redirect light to the wearer's eye, and in which one or more lightguides in the projection system are used to replicate the pupil of the projection system in one axis, and the lightguides which act as eyepieces use a sparse distribution of small mirrors to redirect light to the wearer's eye.
